(19) United States
(12) Patent Application Publication
(10) Pub. No.: US 2025/0282200 A1
(43) Pub. Date: Sep. 11, 2025

(54) THERMAL MANAGEMENT SYSTEM

(71) Applicant: TOYOTA JIDOSHA KABUSHIKI KAISHA, Toyota-shi (JP)

(72) Inventors: Yoichi OGURA, Sunto-gun (JP); Hiroyuki SUGIHARA, Sunto-gun (JP); Ryo NAKABAYASHI, Susono-shi (JP); Ryo MICHIKAWAUCHI, Numazu-shi (JP); Kunihiko HAYASHI, Odawara-shi (JP)

(73) Assignee: TOYOTA JIDOSHA KABUSHIKI KAISHA, Toyota-shi (JP)

(21) Appl. No.: 18/991,719

(22) Filed: Dec. 23, 2024

(30) Foreign Application Priority Data
Mar. 11, 2024 (JP) 2024-037233

(51) Int. Cl. B60H 1/00; B60H 1/03

(52) U.S. Cl. CPC B60H 1/00885; B60H 1/034; B60H 2001/00928

(57) ABSTRACT

The thermal management system comprises a LT radiator, an oil cooler, a chiller, a nine-way valve and a five-way valve, and an ECU. When heating is required, ECU controls the nine-way valve and the five-way valve when the temperature of the heat transfer medium that is flowing through LT radiator is less than the ambient air temperature, to form a first heat transfer medium circuit in which the oil cooler and LT radiator are connected to the chiller, and when the temperature of the heat transfer medium that is flowing through LT radiator is equal to or higher than the ambient air temperature, controls the nine-way valve and the five-way valve to form a second heat transfer medium circuit in which LT radiator is disconnected from the first heat transfer medium circuit.

### CROSS-REFERENCE TO RELATED APPLICATION

This application claims priority to Japanese Patent Application No. 2024-037233 filed on Mar. 11, 2024, incorporated herein by reference in its entirety.

### BACKGROUND

### 1. Technical Field

The present disclosure relates to a thermal management system.

### 2. Description of Related Art

Japanese Unexamined Patent Application Publication No. 2020-185829 (JP 2020-185829 A) discloses an electrified vehicle that is equipped with an in-vehicle temperature control device including a low-temperature radiator and a power control unit (PCU) heat exchanger. The low-temperature radiator and the PCU heat exchanger are connected in series with a chiller when heating is requested in the electrified vehicle. In this case, heat that is supplied from a PCU to a coolant through the PCU heat exchanger, and heat that is supplied to the coolant from the ambient air in the low-temperature radiator (heat absorption by the low-temperature radiator) are used for heating.

### SUMMARY

However, in JP 2020-185829 A, when temperature of the coolant flowing through the low-temperature radiator is higher than ambient air temperature, for example, heat will be undesirably dissipated from the coolant to the ambient air in the low-temperature radiator. Thus, there is a concern that heating efficiency will deteriorate.

The present disclosure has been made to solve the above problems, and an object thereof is to provide a thermal management system capable of suppressing decrease in heating efficiency due to the ambient air temperature being high.

An aspect of the present disclosure provides a thermal management system in which a heat transfer medium circulates, the thermal management system including a radiator, a drive device that includes a heat exchanger and that is configured to generate a driving force, a chiller device, a switching device that switches a flow path of the heat transfer medium, and a control device that controls the switching device.

When heating is requested, the control device may control the switching device to establish a first heat transfer medium circuit in which the heat exchanger, the radiator, and the chiller device are connected, when a temperature of the heat transfer medium that is flowing through the radiator is lower than ambient air temperature, and control the switching device to establish a second heat transfer medium circuit in which the radiator is isolated from the first heat transfer medium circuit, when the temperature of the heat transfer medium that is flowing through the radiator is no lower than the ambient air temperature.

In the thermal management system according to an aspect of the present disclosure, as described above, the first heat transfer medium circuit is established when the temperature of the heat transfer medium that is flowing through the radiator is lower than the ambient air temperature, when heating is requested. Further, the second heat transfer medium circuit is established when the temperature of the heat transfer medium that is flowing through the radiator is no lower than the ambient air temperature. Accordingly, when heat is supplied from the ambient air to the heat transfer medium through the radiator due to the temperature of the heat transfer medium that is flowing through the radiator being lower than the ambient air temperature, the heat supplied to the heat transfer medium in both the radiator and the heat exchanger can be used for heating. Also, when heat is released from the heat transfer medium to the ambient air through the radiator due to the temperature of the heat transfer medium that is flowing through the radiator being no lower than the ambient air temperature, only the heat supplied to the heat transfer medium in the heat exchanger can be used for heating. In this case, the radiator does not contribute to heating, and accordingly decrease in heating efficiency due to heat dissipation from the radiator can be suppressed. Thus, decrease in heating efficiency due to the ambient air temperature being high can be suppressed.

The first heat transfer medium circuit may include a first series circuit in which the heat exchanger, the radiator, and the chiller device are connected in series. The second heat transfer medium circuit may include a second series circuit in which the radiator is isolated from the first series circuit and the heat exchanger and the chiller device are connected in series.

Such a configuration enables easy switching between whether the radiator contributes to heating, by switching between the first series circuit and the second series circuit.

The thermal management system may further include a first temperature sensor that detects the temperature of the heat transfer medium that is flowing into the radiator.

When heating is requested, the control device may control the switching device to establish the first heat transfer medium circuit, when a detected value of the first temperature sensor is lower than the ambient air temperature, and control the switching device to establish the second heat transfer medium circuit, when the detected value of the first temperature sensor is no lower than the ambient air temperature. Such a configuration enables the switching device to be controlled based on a relation between the temperature of the heat transfer medium that is flowing into the radiator and the ambient air temperature, and accordingly the switching device can be controlled based on the relation between the heat transfer medium prior to heat exchange in the radiator and the ambient air temperature. Thus, when there is a temperature condition in which heat will be dissipated to the ambient air at the radiator (i.e., temperature of heat transfer medium >ambient air temperature), the first heat transfer medium circuit can be suppressed from being established more reliably.

The switching device may include a nine-way valve and a five-way valve.

The control device may switch between the first heat transfer medium circuit and the second heat transfer medium circuit by controlling each of the nine-way valve and the five-way valve.

Such a configuration enables easy switching between the first heat transfer medium circuit and the second heat transfer medium circuit by switching the flow path of the heat transfer medium using two different multi-way valves (nine-way valve and five-way valve).

A second temperature sensor that detects the temperature of the heat transfer medium that is flowing through the heat exchanger may be provided.

The control device may control the switching device to establish the first heat transfer medium circuit when a detected value of the second temperature sensor becomes lower than the ambient air temperature in a state in which the second heat transfer medium circuit is established.

With such a configuration, even when the heat transfer medium does not flow through the radiator, switching can be appropriately performed, from the second heat transfer medium circuit to the first heat transfer medium circuit, based on the detected value of the second temperature sensor.

According to the present disclosure, decrease in heating efficiency due to a high ambient air temperature can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a vehicle equipped with a thermal management system according to an embodiment;

FIG. 2 is a diagram illustrating a configuration of a thermal management circuit of a thermal management system according to an embodiment;

FIG. 3 is a diagram illustrating a first heat transfer medium circuit of a thermal management circuit according to an embodiment;

FIG. 4 is a diagram illustrating a second heat transfer medium circuit of a thermal management circuit according to an embodiment;

FIG. 5 is a diagram illustrating a third heat transfer medium circuit of a thermal management circuit according to an embodiment; and

FIG. 6 is a diagram illustrating a control flowchart of an ECU according to an embodiment.

### DETAILED DESCRIPTION OF EMBODIMENTS

Hereinafter, an embodiment of the present disclosure will be described in detail with reference to the drawings. The same or corresponding parts in the drawings are designated by the same reference characters and repetitive description will be omitted.

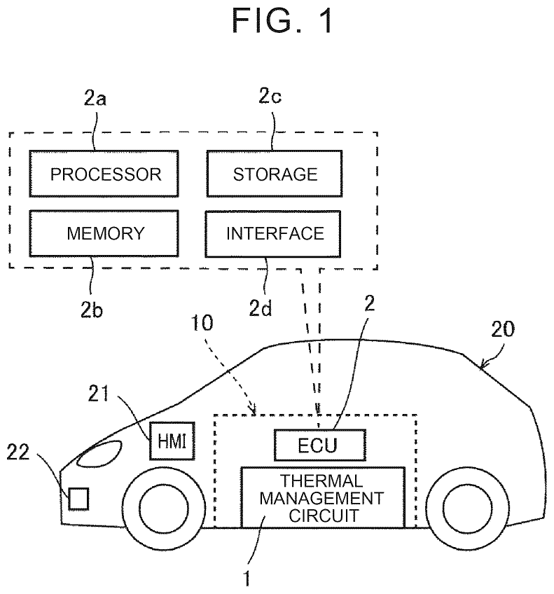

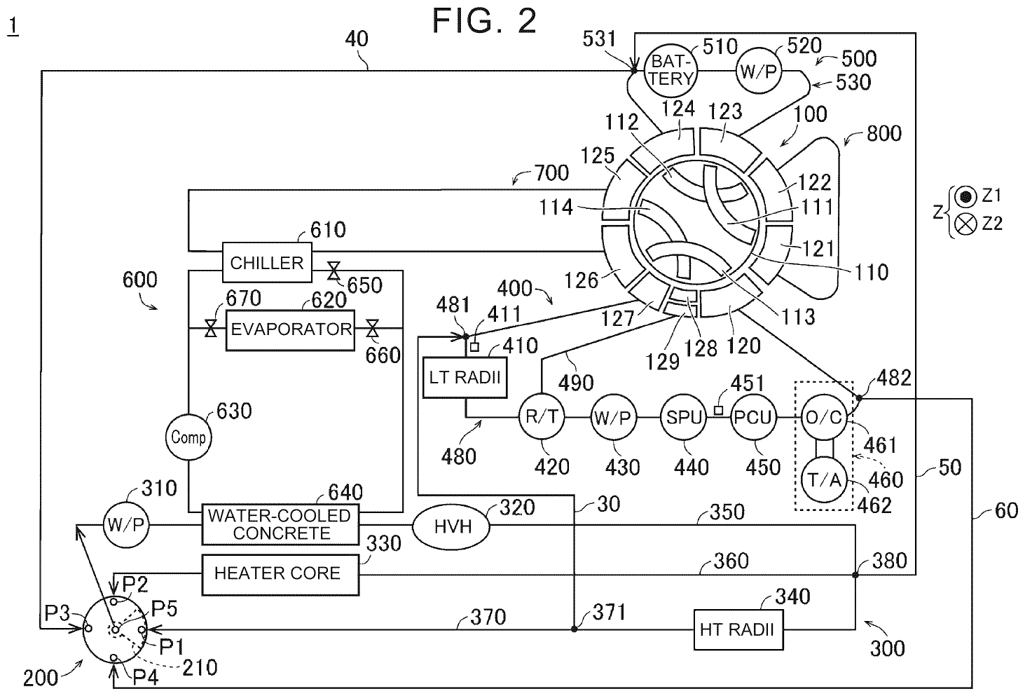

As illustrated in FIG. 1, a configuration in which the thermal management system 10 according to the present disclosure is mounted on a electrified vehicle 20 will be described below. Electrified vehicle 20 is preferably a vehicle equipped with a battery 510 for traveling (described below, FIG. 2). Electrified vehicle 20 is, for example, battery electric vehicle (BEV: Battery Electric Vehicle). Also, electrified vehicle 20 is, for example, hybrid electric vehicle (HEV: Hybrid Electric Vehicle), plug-in hybrid electric vehicle (PHEV: Plug-in Hybrid Electric Vehicle), or fuel cell electric vehicle (FCEV: Fuel Cell Electric Vehicle). However, the use of the thermal management system according to the present disclosure is not limited to a vehicle.

Electrified vehicle 20 includes a thermal management system 10, an HMI (Human Machine Interface) 21, and an ambient air temperature sensor 22. HMI 21 includes, for example, a car navigation device and the like. The ambient air temperature sensor 22 detects the ambient air temperature.

The thermal management system 10 includes a thermal management circuit 1 and an ECU (Electronic Control Unit) 2. Note that ECU 2 is an exemplary “control device” of the present disclosure.

ECU 2 includes a processor 2a, a memory 2b, a storage 2c, and an interface 2d.

The processor 2a is, for example, CPU (Central Processing Unit) or MPU (Micro-Processing Unit). The memory 2b is, for example, RAM (Random Access Memory). The storage 2c is a rewritable non-volatile memory such as HDD (Hard Disk Drive), SSD (Solid State Drive), and flash memory. The storage 2c stores a system program including OS (Operating System) and a control program including computer-readable code required for control operations. The processor 2a realizes various processes by reading out a system program and a control program, expanding the program into a memory 2b, and executing the program. The interface 2d controls the communication between ECU 2 and the components of the thermal management circuit 1.

ECU 2 generates a control command based on a sensor value (for example, a detected value of the ambient air temperature sensor 22) acquired from various sensors included in the thermal management circuit 1, a user operation (for example, an operation requesting heating) received by HMI 21, and the like. ECU 2 outputs the generated control command to the thermal management circuit 1. ECU 2 may be divided into a plurality of ECU for each function. Further, although FIG. 1 shows an exemplary ECU 2 including one processor 2a, ECU 2 may include a plurality of processors. The same applies to the memory 2b and the storage 2c.

### Configuration of the Thermal Management Circuit

FIG. 2 is a diagram illustrating an example of a configuration of the thermal management circuit 1 according to the present embodiment. The thermal management circuit 1 includes a nine-way valve 100, a five-way valve 200, a high-temperature circuit 300, a unit circuit 400, a battery circuit 500, a refrigeration cycle 600, a flow path 700, and a flow path 800. The thermal management circuit 1 includes a flow path 30, a flow path 40, a flow path 50, and a flow path 60. Note that each of the nine-way valve 100 and the five-way valve 200 is an example of a “switching device” of the present disclosure.

The nine-way valve 100 includes a valve body 110 and outer sections 120 to 129. The valve body 110 has a cylindrical shape extending in the Z direction, and is configured to be rotatable about a central axis line (not shown) of the valve body 110. The valve body 110 is surrounded by the outer sections 120 to 129 when viewed from Z1. The valve body 110 rotates in accordance with a control command from ECU 2 (FIG. 1).

The valve body 110 is provided with an internal flow path 111, an internal flow path 112, an internal flow path 113, and an internal flow path 114. When the valve body 110 rotates in accordance with a control command from ECU 2, the positions of the internal flow paths 111 to 114 are changed. As a result, the connection (connection combination) between the outer sections 120 to 129 and the internal flow paths 111 to 114 is changed.

Details will be described later.

The internal flow path 111 is disposed Z1 the internal flow path 112. The internal flow path 113 is disposed Z1 the internal flow path 114. The internal flow path 111 and the internal flow path 113 are arranged at the same position in the Z direction. The internal flow path 112 and the internal flow path 114 are arranged at the same position in the Z direction.

The outer sections 120 to 129 are circumferentially arranged on the outer peripheral side of the valve body 110. The outer sections 120 to 129 are isolated from each other. Although the outer sections 128 and 129 are shown as being arranged side by side in FIG. 2 for clarity, they are actually stacked in the Z direction. The outer section 129 is disposed Z2 the outer section 128.

Each of the outer sections 120 to 126 has substantially the same width in the circumferential direction of the valve body 110. The circumferential width of each of the outer sections 127 to 129 is less than the circumferential width of the outer sections 120 to 126.

The five-way valve 200 has a cylindrical shape extending in the Z direction. The five-way valve 200 has a P5 from the port P1. P4 from the port P1 is an inlet port that allows the heat transfer medium to flow into the five-way valve 200. The port P5 is an outlet port that allows the heat transfer medium to flow out of the five-way valve 200. P4 from the port P1 is in communication with a lower compartment (not shown) that is isolated from one another. That is, the five-way valve 200 is provided with four lower compartments that are isolated from each other. Although not shown, the four sections have the same shape (a sector shape having a central angle of 90 degrees when viewed from Z1 side). The port P5 communicates with an upper compartment (not shown) provided Z1 of the four lower compartments.

The flow condition of the heat transfer medium from the port P1 to P5 is controlled by a control command from ECU 2 (FIG. 1). Specifically, ECU 2 changes the position of the opening 210. Inside the five-way valve 200, a partition plate (not shown) for partitioning the four lower and upper partitions is provided, the opening 210 is formed in the partition plate. The partition plate is rotationally moved about the central axial line of the five-way valve 200 having a cylindrical shape by a control command from ECU 2. As a result, the lower section overlapping with the opening 210 in the Z direction changes. The port P5 is only in communication with a port that communicates with the lower compartment that overlaps the opening 210 in the Z-direction.

The opening 210 has a sector shape with a central angle of about 90 degrees when viewed from Z1. Thus, one or two of the four lower compartments may simultaneously overlap the opening 210 in the Z direction. This causes one or two ports of P4 from the port P1 to communicate with the port P5.

The high temperature circuit 300 includes a water pump 310, a HVH (High Voltage Heater) 320, a heater core 330, and a HT (High Temperature) radiator 340. The water pump 310 circulates the heat transfer medium in the high temperature circuit 300 in accordance with a control command from ECU 2 (FIG. 1).

The high temperature circuit 300 includes a flow path 350, a flow path 360, and a flow path 370. The flow path 350 connects the port P5 and the branch point 380. The flow path 350 is provided with a water pump 310 and a HVH 320. The flow path of the flow path 350 between the water pump 310 and HVH 320 is also connected to a water-cooled condenser 640 of the refrigeration cycle 600, which will be described later. That is, in the water-cooled condenser 640, heat exchange is performed between the heat transfer medium circulating in the refrigeration cycle 600 and the heat transfer medium that is flowing through the flow path 350.

The flow path 360 connects the branch point 380 and the port P2. The flow path 360 is provided with a heater core 330.

The flow path 370 connects the branch point 380 and the port P1. A HT radiator 340 is provided in the flow path 370.

Unit circuit 400 includes a LT (Low Temperature) radiator 410, a reserve tank 420, and a water pump 430. The unit circuit 400 includes a SPU (Smart Power Unit) 440, a PCU (Power Control Unit) 450, and a drive unit 460. The drive unit 460 is a device capable of generating a driving force of electrified vehicle 20 (FIG. 1). The drive unit 460 includes an oil cooler (O/C) 461 and a transaxle (T/A) 462. Note that LT radiator 410 and the oil cooler 461 are exemplary “radiators” and “heat exchangers” of the present disclosure, respectively. Each of PCU 450 and the drive unit 460 is an exemplary “drive device” of the present disclosure.

The water pump 430 circulates the heat transfer medium in accordance with a control command from ECU 2 (FIG. 1). The water pump 430 delivers a heat transfer medium to SPU 413.

The unit circuit 400 includes a temperature sensor 411 and a temperature sensor 451. The temperature sensor 411 detects the temperature of the heat transfer medium that is flowing through LT radiator 410. Specifically, the temperature sensor 411 detects the temperature of the heat transfer medium that is flowing into LT radiator 410. For example, the temperature sensor 411 detects the temperature of the heat transfer medium passing through the heat transfer medium inlet of LT radiator 410.

The temperature sensor 451 detects the temperature of the heat transfer medium that is flowing through PCU 450 (the heat exchanger of PCU 450). The temperature sensor 451 may detect the temperature of the heat transfer medium immediately before flowing through PCU 450 (the heat exchanger of PCU 450) (for example, the heat transfer medium inlet in the heat exchanger of PCU 450). Further, the temperature sensor 451 may detect the temperature of the heat transfer medium that is flowing through the oil cooler 461 or the heat transfer medium immediately before flowing through the oil cooler 461 (for example, the heat transfer medium inlet in the oil cooler 461). The heat exchanger of PCU 450 is an exemplary “heat exchanger” of the present disclosure.

The unit circuit 400 includes a flow path 480 and a flow path 490. The flow path 480 connects the outer section 127 and the outer section 120 of the nine-way valve 100. The flow path 480 is provided with a LT radiator 410, a reserve tank 420, a water pump 430, a SPU 440, PCU 450, and an oil cooler 461. SPU 440, like PCU 450, includes a heat exchanger (not shown) that exchanges heat with the heat transfer medium of the flow path 480. The oil cooler 461 exchanges heat between the transaxle 462 and the heat transfer medium in the flow path 480. Instead of the oil cooler 461, a transaxle 462 may be provided in the flow path 480.

The flow path 490 connects the outer section 129 of the nine-way valve 100 and the reserve tank 420.

The battery circuit 500 includes a battery 510, a water pump 520, and a flow path 530. The water pump 520 delivers a heat transfer medium to the battery 510 side. The water pump 520 circulates the heat transfer medium in accordance with a control command from ECU 2 (FIG. 1). Note that the battery 510 is an example of a “power storage device” of the present disclosure.

The flow path 530 connects the outer section 123 and the outer section 124 of the nine-way valve 100. The flow path 530 is provided with a battery 510 and a water pump 520. The battery 510 includes a heat exchanger (not shown) that exchanges heat with the heat transfer medium of the flow path 530.

The refrigeration cycle 600 includes a chiller 610, an evaporator 620, a compressor 630, and a water-cooled condenser 640. The refrigeration cycle 600 includes an expansion valve 650, an expansion valve 660, and a EPR (Evaporative Pressure Regulator) 670. A heat transfer medium (a gas-phase refrigerant or a liquid-phase refrigerant) circulating in the refrigeration cycle 600 flows through one/both of the first path and the second path. The first path is the path of compressor 630-water cooled condenser 640-expansion valve 660-evaporator 620-EPR 670-compressor 630. The second path is the path of compressor 630-water cooled condenser 640-expansion valve 650-chiller 610-compressor 630. The chiller 610 is an example of a “chiller device” of the present disclosure.

The flow path 700 connects the outer section 125 and the outer section 126 of the nine-way valve 100. The flow path 700 is also connected to the chiller 610 of the refrigeration cycle 600. That is, the heat transfer medium that is flowing through the flow path 700 and the heat transfer medium of the refrigeration cycle 600 are heat-exchanged in the chiller 610.

The flow path 800 connects the outer section 121 and the outer section 122 of the nine-way valve 100. A device or the like is not provided in the flow path 800.

The flow path 30 connects the branch point 371 and the merging portion 481. The branch point 371 is provided between HT radiator 340 and the five-way valve 200 in the flow path 370 of the high temperature circuit 300. The merging portion 481 is provided between LT radiator 410 and the nine-way valve 100 in the flow path 480 of the unit circuit 400. That is, the heat transfer medium of the flow path 370 branched into the flow path 30 at the branch point 371 is merged into the heat transfer medium of the flow path 480 at the merging portion 481.

The flow path 40 connects the port P3 of the nine-way valve 100 and a branch point 531 of the flow path 530 of the battery circuit 500 provided between the battery 510 and the outer section 124. That is, the heat transfer medium in the flow path 530 branched into the flow path 40 at the branch point 531 flows into the five-way valve 200 from the port P3.

The flow path 50 connects the branch point 380 of the high-temperature circuit 300 and the branch point 531 of the battery circuit 500. That is, the heat transfer medium of the high-temperature circuit 300 (the flow path 350) branched into the flow path 50 at the branch point 380 merges into the flow path 530 at the branch point 531.

The flow path 60 connects the port P4 of the five-way valve 200 and a branch point 482 of the flow path 480 of the unit circuit 400 between the drive unit 460 (oil cooler 461) and the outer section 120 of the nine-way valve 100. That is, the heat transfer medium in the flow path 480 branched into the flow path 60 at the branch point 482 flows into the five-way valve 200 from the port P4.

When the temperature of the heat transfer medium that is flowing through LT radiator is higher than the ambient air temperature, heat is dissipated from the heat transfer medium to the ambient air in LT radiator in a conventional thermal management system. Thus, there is a concern that heating efficiency will deteriorate.

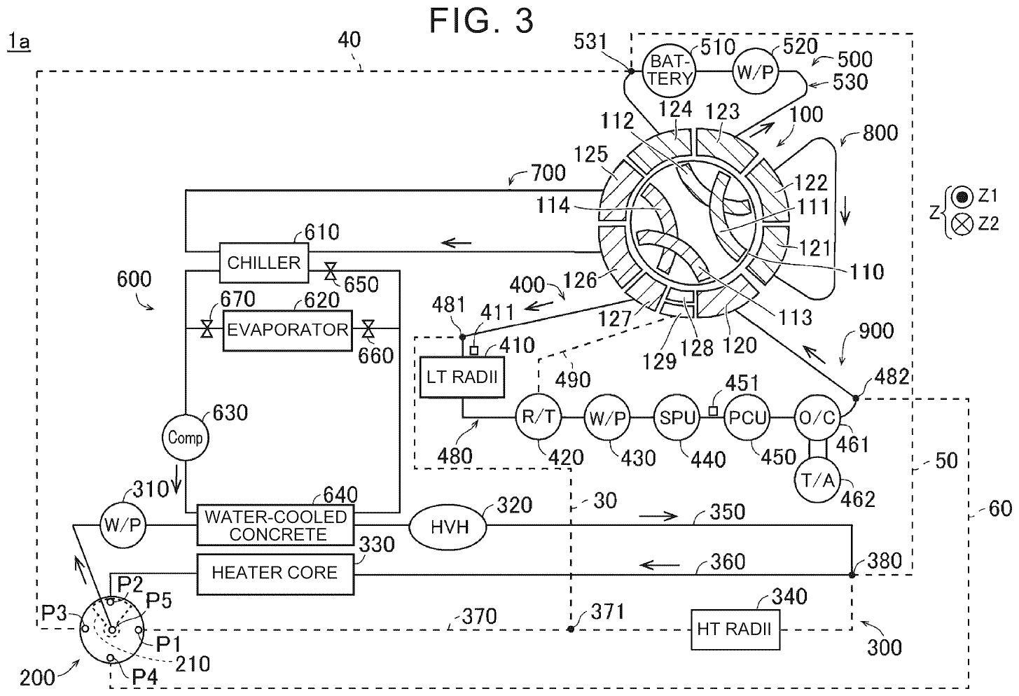

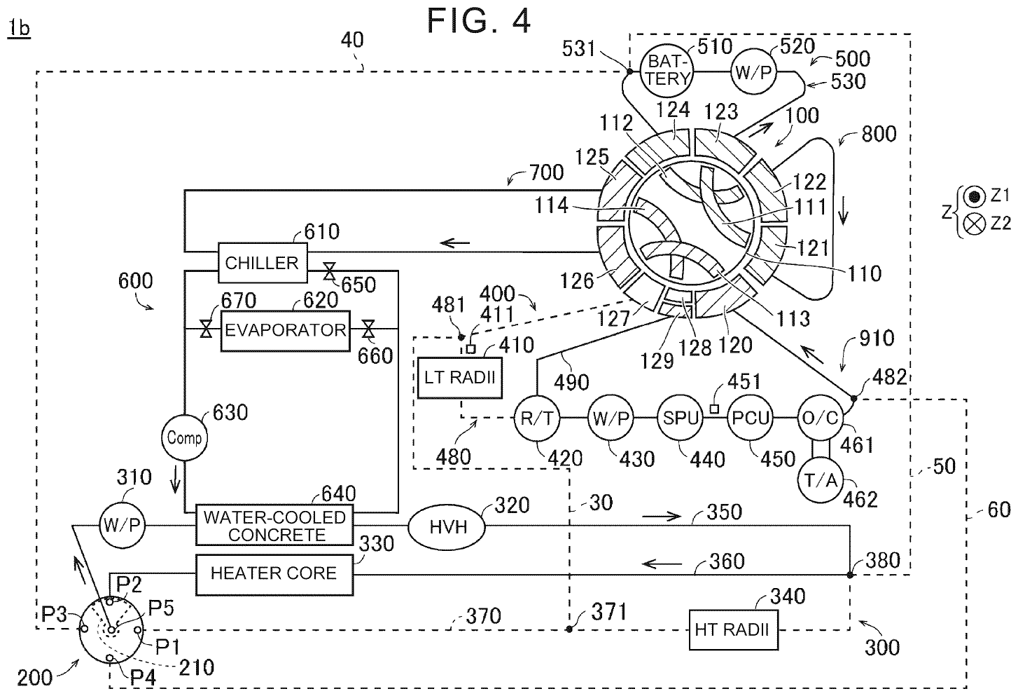

Therefore, in the present embodiment, ECU 2 controls the nine-way valve 100 and the five-way valve 200 when the temperature of the heat transfer medium that is flowing through LT radiator 410 is lower than the ambient air temperature when heating is requested. This forms a first heat transfer medium circuit 1a (FIG. 3) in which each of the oil cooler 461 and LT radiator 410 is connected to the chiller 610. In addition, ECU 2 controls the nine-way valve 100 and the five-way valve 200 when the temperature of the heat transfer medium that is flowing through LT radiator is equal to or higher than the ambient air temperature when heating is requested. Accordingly, the second heat transfer medium circuit 1b (FIG. 4) in which LT radiator 410 is disconnected from the first heat transfer medium circuit 1a is formed.

### First Heat Transfer Medium Circuit

FIG. 3 is a diagram illustrating a first heat transfer medium circuit 1a of the thermal management circuit 1. In the first heat transfer medium circuit 1a, LT radiator 410, the oil cooler 461 (drive unit 460 (FIG. 2)), and the chiller 610 are provided in a common circulation circuit. Discuss in detail below.

The internal flow path 111 of the nine-way valve 100 connects the outer section 121 and the outer section 123. The internal flow path 112 connects the outer section 122 and the outer section 124. The internal flow path 113 connects the outer section 120 and the outer section 126. The internal flow path 114 connects the outer section 125 and the outer section 127.

In the five-way valve 200, the opening 210 overlaps only the lower compartment that communicates with the port P2. Thus, the port P5 is in communication with only the port P2 of P4 from the port P1.

As a result, the heat transfer medium circulates through the circuit of the five-way valve 200 (port P5)-the water pump 310-the water-cooled condenser 640-HVH 320-heater core 330-the five-way valve 200 (port P2) (the circulation circuit in the high-temperature circuit 300).

The heat transfer medium also circulates in the circuit of reserve tank 420-water pump 430-SPU 440-PCU 450-oil cooler 461-outer compartment 120-internal flow path 113-outer compartment 126-chiller 610-outer compartment 125-internal flow path 114-outer compartment 127-LT radiator 410-reserve tank 420.

That is, in the first heat transfer medium circuit 1a, a series circuit 900 is formed in which LT radiator 410, the oil cooler 461 (and PCU 450 heat exchanger), and the chiller 610 are connected in series. The series circuit 900 includes a portion of the flow path 480, an internal flow path 113, and a portion of the flow path 700. The series circuit 900 is an example of a “first series circuit” of the present disclosure.

In addition, the heat transfer medium circulates in the circuits of the water pump 520, the battery 510, the outer section 124, the internal flow path 112, the outer section 122, the flow path 800, the outer section 121, the internal flow path 111, the outer section 123, and the water pump 520.

In addition, in the refrigeration cycle 600, the heat transfer medium circulates through the circuit of the chiller 610-compressor 630-water-cooled condenser 640-expansion valve 650-chiller 610.

In the first heat transfer medium circuit 1a, heat exchange with the ambient air is performed in LT radiator 410, and heat exchange is performed in the oil cooler 461 (and the heat exchanger of PCU 450), and the heat transfer medium flows through the chiller 610. The heat supplied to the refrigeration cycle 600 through the chiller 610 is used for heating by the heater core 330 in the high-temperature circuit 300.

In the first heat transfer medium circuit 1a, the heat transfer medium does not flow through each of the flow path 30, the flow path 40, the flow path 50, and the flow path 60. In the first heat transfer medium circuit 1a, the heat transfer medium does not flow through the flow path 490.

### Second Heat Transfer Medium Circuit

FIG. 4 is a diagram illustrating a second heat transfer medium circuit 1b of the thermal management circuit 1. The second heat transfer medium circuit 1b is a circuit in which LT radiator 410 is disconnected from the first heat transfer medium circuit 1a.

The internal flow path 111 of the nine-way valve 100 connects the outer section 121 and the outer section 123. The internal flow path 112 connects the outer section 122 and the outer section 124. The internal flow path 113 connects the outer section 120 and the outer section 126. The internal flow path 114 connects the outer section 125 and the outer section 129. That is, only the outer sections connected by the internal flow path 114 are different from the first heat transfer medium circuit 1a.

Similar to the first heat transfer medium circuit 1a, in the five-way valve 200, the opening 210 overlaps only the lower compartment that communicates with the port P2. Thus, similar to the first heat transfer medium circuit 1a, the port P5 is in communication with only the port P2 of P4 from the port P1.

As a result, similar to the first heat transfer medium circuit 1a, the heat transfer medium circulates through the circuit of the five-way valve 200 (port P5)-water pump 310-water cooled condenser 640-HVH 320-heater core 330-five-way valve 200 (port P2).

The heat transfer medium also circulates in the circuit of the reserve tank 420-water pump 430-SPU 440-PCU 450-oil cooler 461-outer compartment 120-internal flow path 113-outer compartment 126-chiller 610-outer compartment 125-internal flow path 114-outer compartment 129-reserve tank 420. That is, LT radiator 410 is bypassed with respect to the circulation circuit in the first heat transfer medium circuit 1a (FIG. 3).

Specifically, in the second heat transfer medium circuit 1b, a series circuit 910 in which LT radiator 410 is disconnected from the series circuit 900 (FIG. 3) is formed. In the series circuit 910, the oil cooler 461 (and PCU 450 heat exchanger) and the chiller 610 are connected in series. The series circuit 910 includes a portion of the flow path 480 downstream of LT radiator 410, an internal flow path 113, and a portion of the flow path 700. The series circuit 910 is an example of a “second series circuit” of the present disclosure.

In the second heat transfer medium circuit 1b, similarly to the first heat transfer medium circuit 1a, the heat transfer medium circulates in the circuits of the water pump 520, the battery 510, the outer section 124, the internal flow path 112, the outer section 122, the flow path 800, the outer section 121, the internal flow path 111, the outer section 123, and the water pump 520.

In the second heat transfer medium circuit 1b, similarly to the first heat transfer medium circuit 1a, in the refrigeration cycle 600, the heat transfer medium circulates in the circuit of the chiller 610-compressor 630-water-cooled condenser 640-expansion valve 650-chiller 610.

In the second heat transfer medium circuit 1b, the heat transfer medium having undergone heat exchange in the oil cooler 461 (and the heat exchanger of PCU 450) flows through the chiller 610. The heat supplied to the refrigeration cycle 600 through the chiller 610 is used for heating by the heater core 330 in the high-temperature circuit 300. Since the heat transfer medium does not flow in LT radiator 410, heat exchange between the heat transfer medium and the ambient air in LT radiator 410 is not performed.

In the second heat transfer medium circuit 1b, similarly to the first heat transfer medium circuit 1a, the heat transfer medium does not flow through each of the flow path 30, the flow path 40, the flow path 50, and the flow path 60. In the second heat transfer medium circuit 1b, the heat transfer medium does not flow through the flow path 490, similarly to the first heat transfer medium circuit 1a.

### Third Heat Transfer Medium Circuit

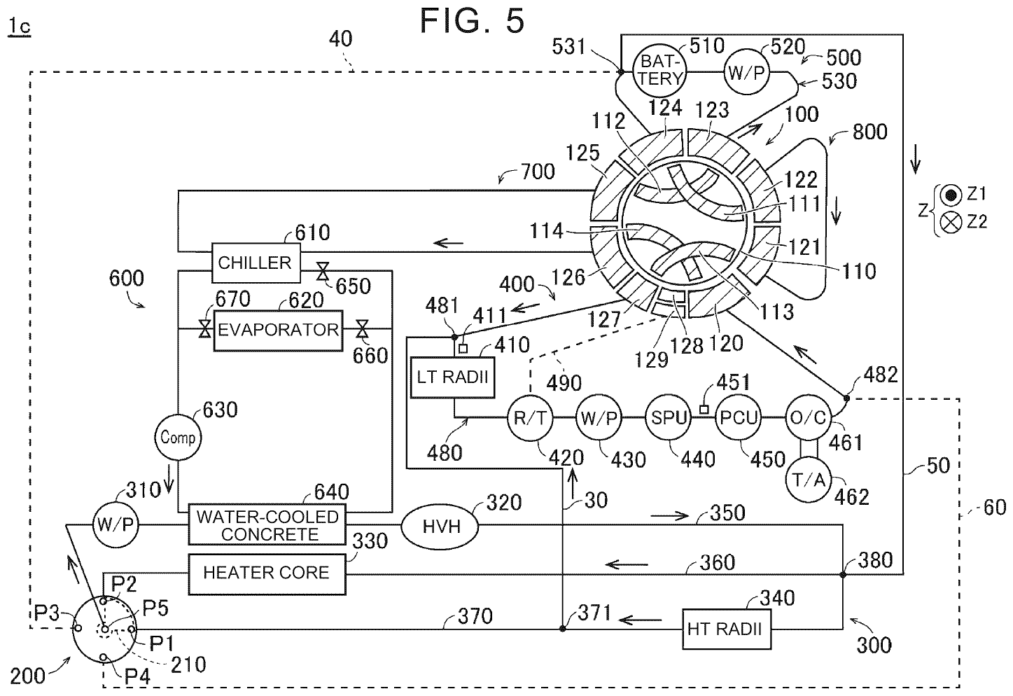

FIG. 5 is a diagram illustrating a third heat transfer medium circuit 1c of the thermal management circuit 1. The third heat transfer medium circuit 1c is a circuit for passing water to the respective devices of the thermal management circuit 1. Thus, it is possible to eliminate the liquid accumulation and the like.

The internal flow path 111 of the nine-way valve 100 connects the outer section 122 and the outer section 124. The internal flow path 112 connects the outer section 123 and the outer section 125. The internal flow path 113 connects the outer section 121 and the outer section 127. The internal flow path 114 connects the outer section 120 and the outer section 126.

In the five-way valve 200, the opening 210 overlaps the lower compartment that communicates with each of the port P1 and P2. Thus, the port P5 is in communication with the port P1 of P4 and P2 from the port P1.

Thus, the heat transfer medium circulates through the first circuit of the five-way valve 200 (port P5)-water pump 310-water cooled condenser 640-HVH 320-heater core 330-five-way valve 200 (port P2).

The heat transfer medium also circulates through the second circuit of the five-way valve 200 (port P5)-water pump 310-water cooled condenser 640-HVH 320-HT radiator 340-five-way valve 200 (port P1).

The heat transfer medium of the second circuit is branched into the flow path 30 at the branch point 371. The heat transfer medium branched into the flow path 30 circulates in the third circuit. The third circuit is the circuit of LT radiator 410-reserve tank 420-water pump 430-SPU 440-PCU 450-oil cooler 461-outer section 120-inner section 114-outer section 126-chiller 610-outer section 125-inner section 112-outer section 123-water pump 520-battery 510-outer section 124-inner section 111-outer section 122-flow path 800-outer section 121-inner section 113-outer section 127-LT radiator 410.

The heat transfer medium of the third circuit is branched into the flow path 50 at the branch point 531, and flows into the high-temperature circuit 300 from the branch point 380.

In the third heat transfer medium circuit 1c, the heat transfer medium does not flow through each of the flow path 40 and the flow path 60. In the third heat transfer medium circuit 1c, the heat transfer medium does not flow through the flow path 490.

### ECU Control Flowchart

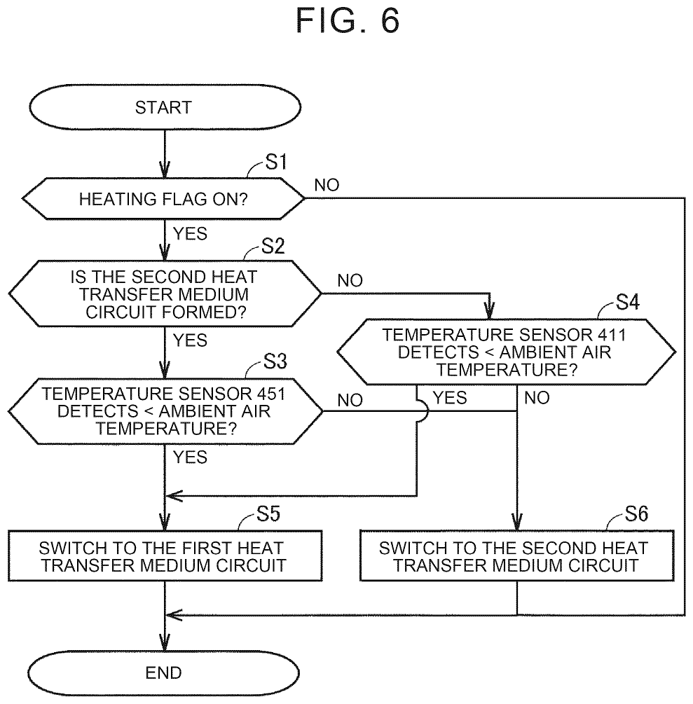

FIG. 6 is a diagram illustrating an exemplary control flow executed by ECU 2 (FIG. 1). The control flow illustrated in FIG. 6 may be executed (started) at a predetermined cycle (for example, every minute).

In S1, ECU 2 determines whether the heating flag is ON. The heating flag is ON when the user performs a predetermined operation for requesting heating in HMI 21 (FIG. 1). If the heating flag is ON (Yes in S1), the process proceeds to S2. When the heating flag is OFF (No in S1), the process ends.

In S2, ECU 2 determines whether the second heat transfer medium circuit 1b (FIG. 4) is formed. For example, ECU 2 may make the above determination from the status of the nine-way valve 100 and the five-way valve 200. When the second heat transfer medium circuit 1b is formed (Yes in S2), the process proceeds to S3. If the second heat transfer medium circuit 1b is not formed (No in S2), the process proceeds to S4.

In S3, ECU 2 determines whether the detected value of the temperature sensor 451 (FIG. 2) is less than the ambient air temperature. Specifically, ECU 2 determines whether or not the detected value of the temperature sensor 451 is less than the detected value of the ambient air temperature sensor 22 (FIG. 1). When the detected value of the temperature sensor 451 is less than the ambient air temperature (Yes in S3), the process proceeds to S5. When the detected value of the temperature sensor 451 is equal to or higher than the ambient air temperature (No in S3), the process proceeds to S6. The thresholds in S3 may be, for example, the ambient air temperature+α (for example, α=3° C.) instead of the ambient air temperature.

In S4, ECU 2 determines whether the detected value of the temperature sensor 411 (FIG. 2) is less than the ambient air temperature. Specifically, ECU 2 determines whether or not the detected value of the temperature sensor 411 is less than the detected value of the ambient air temperature sensor 22 (FIG. 1). When the detected value of the temperature sensor 411 is less than the ambient air temperature (Yes in S4), the process proceeds to S5. When the detected value of the temperature sensor 411 is equal to or higher than the ambient air temperature (No in S4), the process proceeds to S6.

In S5, ECU 2 controls the five-way valve 200 and the nine-way valve 100 to switch the thermal management circuit 1 to the first heat transfer medium circuit 1a (FIG. 3). When the thermal management circuit 1 is switched to the first heat transfer medium circuit 1a, the condition is maintained.

As a result, a series circuit 900 (FIG. 3) in which LT radiator 410, the oil cooler 461, and the chiller 610 are connected in series is formed. Therefore, the heat transfer medium absorbed in each of LT radiator 410 and the oil cooler 461 flows through the chiller 610. As a result, the amount of heat transmitted to the refrigeration cycle 600 through the chiller 610 becomes relatively large, and thus the power consumption of the compressor 630 can be reduced. This improves the efficiency of heating by the heater core 330.

In S6, ECU 2 controls the five-way valve 200 and the nine-way valve 100 to switch the thermal management circuit 1 to the second heat transfer medium circuit 1b (FIG. 3). When the thermal management circuit 1 is switched to the second heat transfer medium circuit 1b, the condition is maintained.

As a result, the series circuit 910 (FIG. 4) in which the oil cooler 461 and the chiller 610 are connected in series is formed, so that the heat transfer medium absorbed by the oil cooler 461 flows through the chiller 610. Further, since the heat transfer medium that is flowing through the chiller 610 does not pass through LT radiator 410, heat is not dissipated to the ambient air in LT radiator 410. As a consequence, the amount of heat transferred to the refrigeration cycle 600 in the chiller 610 can be suppressed from decreasing due to heat dissipation in LT radiator 410. Accordingly, it is possible to suppress an increase in power consumption of the compressor 630. As a result, lowering of the heating efficiency by the heater core 330 is suppressed.

ECU 2 may also control the five-way valve 200 and the nine-way valve 100 while the heating flag is OFF to switch the thermal management circuit 1 to the third heat transfer medium circuit 1c (FIG. 5).

As described above, in the present embodiment, when heating is requested, ECU 2 controls the nine-way valve 100 and the five-way valve 200 when the temperature of the heat transfer medium that is flowing through LT radiator 410 is lower than the ambient air temperature. Thus, the first heat transfer medium circuit 1a in which the oil cooler 461, LT radiator 410, and the chiller 610 are connected is formed. ECU 2 also controls the nine-way valve 100 and the five-way valve 200 when the temperature of the heat transfer medium that is flowing through LT radiator 410 is equal to or higher than the ambient air temperature. Thus, the second heat transfer medium circuit 1b in which LT radiator 410 is disconnected from the first heat transfer medium circuit 1a is formed. Thus, by forming the first heat transfer medium circuit 1a, heat absorbed from the ambient air in LT radiator 410 can be used for heating. Further, by forming the second heat transfer medium circuit 1b, it is possible to suppress the heat dissipation from the heat transfer medium to the ambient air in LT radiator 410 from lowering the heating efficiency.

In the above embodiment, LT radiator 410, the oil cooler 461, and the chiller 610 are connected in series so that both LT radiator 410 and the oil cooler 461 contribute to heating, but the present disclosure is not limited thereto. The circuit to which LT radiator 410 and the chiller 610 are connected and the circuit to which the oil cooler 461 and the chiller 610 are connected may be separated and independent of each other.

In the above embodiment, the heat transfer medium circuit (1a, 1b) is switched based on the magnitude relation between the temperature of the heat transfer medium immediately before flowing into LT radiator 410 (flowing through the heat transfer medium inlet of LT radiator 410) and the ambient air temperature. For example, the heat transfer medium circuit may be switched based on the magnitude relation between the temperature of the heat transfer medium immediately after flowing out of LT radiator 410 (flowing through the heat transfer medium outlet of LT radiator 410) and the ambient air temperature. In this case, the first heat transfer medium circuit 1a may be formed when the temperature of the heat transfer medium that is flowing through the heat transfer medium outlet is lower than the ambient air temperature (or the ambient air temperature+α). In addition, the second heat transfer medium circuit 1b may be formed when the temperature of the heat transfer medium that is flowing through the heat transfer medium outlet is equal to or higher than the ambient air temperature (or the ambient air temperature+α).

In the above-described embodiment, the switching of the heat transfer medium circuit (1a, 1b) is performed based on the magnitude relation between the detected value of the temperature sensor 451 and the ambient air temperature when the second heat transfer medium circuit 1b is formed. Even when the second heat transfer medium circuit 1b is formed, the heat transfer medium circuit may be switched based on the magnitude relation between the detected value of the temperature sensor 411 and the ambient air temperature.

In the above embodiment, the state of the thermal management circuit 1 is switched by controlling the nine-way valve 100 and the five-way valve 200, but the present disclosure is not limited thereto. The switching valve may have other configurations (e.g., a multi-way valve other than a five-way valve and a nine-way valve).

Although the reference-temperature sensors (411, 451) are switched based on whether or not the second heat transfer medium circuit 1b is formed, the present disclosure is not limited thereto. For example, LT radiator 410 may be configured to detect whether or not the heat transfer medium is circulating, and the temperature sensor to be referred to may be switched based on the detection result. For example, the determination may be performed based on a circuit pattern corresponding to the states of the nine-way valve 100 and the five-way valve 200. Further, the determination may be performed based on a detected value of a sensor (for example, a pressure sensor, a flow rate sensor, or the like) provided at a heat transfer medium inlet or the like of LT radiator 410.

In the above embodiment, PCU 450 and the drive unit 460 (the oil cooler 461 and the transaxle 462) are connected in series. PCU 450 and the drive unit 460 may be connected in parallel.

In the above embodiment, an example in which the detection value of the ambient air temperature sensor 22 is used as the information of the ambient air temperature has been described, but the present disclosure is not limited thereto. For example, information on the ambient air temperature acquired by communication to the Internet or the like may be used.

Note that the configurations (processes) of the above-described embodiments and the above-described modification examples may be combined with each other.

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. A thermal management system in which a heat transfer medium circulates, the thermal management system comprising:
a radiator;
a drive device that includes a heat exchanger and that is configured to generate a driving force;
a chiller device;
a switching device that switches a flow path of the heat transfer medium; and
a control device that controls the switching device, wherein, when heating is requested, the control device
controls the switching device to establish a first heat transfer medium circuit in which the heat exchanger, the radiator, and the chiller device are connected, when a temperature of the heat transfer medium that is flowing through the radiator is lower than ambient air temperature, and
controls the switching device to establish a second heat transfer medium circuit in which the radiator is isolated from the first heat transfer medium circuit, when the temperature of the heat transfer medium that is flowing through the radiator is no lower than the ambient air temperature.

2. The thermal management system according to claim 1, wherein:
the first heat transfer medium circuit includes a first series circuit in which the heat exchanger, the radiator, and the chiller device are connected in series; and
the second heat transfer medium circuit includes a second series circuit in which the radiator is isolated from the first series circuit and the heat exchanger and the chiller device are connected in series.

3. The thermal management system according to claim 1, further comprising a temperature sensor that detects the temperature of the heat transfer medium that is flowing into the radiator, wherein, when heating is requested, the control device
controls the switching device to establish the first heat transfer medium circuit, when a detected value of the temperature sensor is lower than the ambient air temperature, and
controls the switching device to establish the second heat transfer medium circuit, when the detected value of the temperature sensor is no lower than the ambient air temperature.

4. The thermal management system according to claim 1, wherein:
the switching device includes a nine-way valve and a five-way valve; and
the control device switches between the first heat transfer medium circuit and the second heat transfer medium circuit by controlling each of the nine-way valve and the five-way valve.

5. The thermal management system according to claim 1, further comprising a temperature sensor that detects the temperature of the heat transfer medium that is flowing through the heat exchanger, wherein the control device controls the switching device to establish the first heat transfer medium circuit when a detected value of the temperature sensor becomes lower than the ambient air temperature in a state in which the second heat transfer medium circuit is established.
